(19) United States
(12) Patent Application Publication
(10) Pub. No.: US 2018/0085995 A1
(43) Pub. Date: Mar. 29, 2018

(54) 3D MANUFACTURING USING MULTIPLE MATERIAL DEPOSITION AND/OR FUSION SOURCES SIMULTANEOUSLY WITH SINGLE OR MULTI-FLUTE HELICAL BUILD SURFACES

(71) Applicant: NEW YORK UNIVERSITY, New York, NY (US)

(72) Inventor: Michael A. DAVIS, Mussafah (AE)

(21) Appl. No.: 15/815,558

(22) Filed: Nov. 16, 2017

Related U.S. Application Data
(63) Continuation-in-part of application No. 14/145,423, filed on Dec. 31, 2013, now abandoned.
Application No. 14/145,423 is a continuation-in-part of application No. PCT/US2016/048363, filed on Aug. 24, 2016.
(60) Provisional application No. 61/748,937, filed on Jan. 4, 2013.
(60) Provisional application No. 61/913,741, filed on Dec. 9, 2013.
(60) Provisional application No. 62/209,740, filed on Aug. 25, 2015.

(51) Int. Cl. B29C 64/141; B33Y 10/00; B33Y 30/00; B33Y 50/02; B29C 64/245

(52) U.S. Cl. CPC B29C 64/141; B33Y 10/00; B29C 64/245; B33Y 50/02; B33Y 30/00

(57) ABSTRACT

A method and apparatus to improve the speed of the free-form manufacture of complex systems uses the helical build process to 3D print or manufacture objects by using multiple material fusion sources simultaneously with single- or multi-flute helical build surfaces. As a result of the stationary material deposition line in a helical build machine, the speed of the fusion process can be improved by simultaneously using multiple fusion in sources in parallel on each fusion line. The geometry of the fixed location of the fusion line allows for changes in the optics of laser based machines which may lead to improvements in speed of over 100× compared to the speed of a single flute machines. Speed improvements are possible for all types additive manufacturing processes that use the helical build approach.

This application is a continuation-in-part of co-pending U.S. patent application Ser. No. 14/145,423 filed Dec. 31, 2013, which claims priority benefit of U.S. Provisional Application Nos. 61/748,937 filed Jan. 4, 2013 and 61/913,741 filed Dec. 9, 2013; and is a continuation-in-part of PCT/US2016/048363 filed Aug. 24, 2016, which claims priority benefit of U.S. Provisional Application No. 62/209,740 filed Aug. 25, 2015, all of which are incorporated herein by reference in their entirety.

### FIELD OF THE INVENTION

The present invention generally relates to devices and methods for manufacturing solid objects by layer-by-layer deposition of material for single parts or complex systems which are then incorporated into or used to manufacture complex systems. Certain embodiments extend the 3D printing process from using one material fusion process to using multiple material fusion processes and multiple fusion sources for each process simultaneously.

### BACKGROUND OF THE INVENTION

Typically, complex systems consist of the combination of multiple three-dimensional parts that have been separately manufactured by different processes and have been assembled to achieve the functionality of the final product. The manufacture of 3D parts can be achieved by traditional methods such as casting and machining or by 3D printing which uses a process to add material, layer-by-layer, to build a part. Current 3D printers use a flat platform which acts as the build surface and after a layer of material is added to the platform, the surface moves away from the source of the material and then another layer of material is added to the previously added layer of material. By repeating the process, a 3D object is made, layer-by-layer. This technique is known as rapid-prototyping, rapid-manufacturing and additive manufacturing.

Current production quality systems are characterized by a build envelop that consist of a rectangular box with fixed dimensions which is described by a Cartesian coordinate system. These systems include a build platform which normally travels in the z-direction in a step-wise motion, a layer deposition mechanism which moves in a single x-y plane along one or both axis (X and Y), and a mechanism for binding each freshly deposited layer of material to the previous layer. The material deposition occurs at the z-coordinate which defines the exposed surface on the build platform. Currently used processes are intermittent in nature and use several clearly defined process steps in a well-defined sequential order that repeats throughout the build process. The processes used can be defined as 1) material deposition, 2) fusing, 3) movement of the build platter to a new z-location. With current technology, each of these three processes must be used in a sequential order in time and all three processes cannot occur at the same time but must be done one after the other. Typically, each process only starts after the previous process is finished. Currently some existing systems can combine steps one and two so that that they nearly happen at the same time but no existing systems can combine all three and this is the intermittent nature of existing systems.

With current systems, material is deposited by one of several techniques which can be divided into categories A and B. Category A machines use a single motion to deposit a layer of material that covers the entire surface of the build platform and the deposited material can be either liquid or powder. After the layer has been deposited, a fusing process is used to selectively fuse only the material in the layer that is to be part of the finished object. The fusing process consists of one of many techniques which include electron beam melting, selective laser sintering, the spray deposition of a binder which can be either heat or light cured, and selective light curing either with lasers or an optical masking system. After the material deposition and curing processes have been completed, the build platform moves in the z-direction away from the source of the material and the process is repeated.

Category B consists of the selective deposition of a liquefied build material combined with an “as-deposited” curing process. The deposition of the material is limited to just the locations in the X-Y plane of the build surface where material is to be added to the final form of the part. The deposition process is done using one of several processes which include the extrusion of a melted plastic, the spraying of a photo-sensitive polymer (epoxy resin) onto the build surface, or the deposition of a thin layer of photo-sensitive epoxy resin onto the build surface with a selective exposure of the liquid layer to the light and after exposure, the unused resin is removed.

The melted plastic extrusion technique is known as fused deposition because after the extruded plastic is deposited it cools and solidifies and, in the process, it fuses with previously extruded material.

The curing of the photo-sensitive resins with light known as cross-linked polymerization is used with two styles of machines. One type of machine uses ink-jet style print heads to deposit the build/support material(s) and the other type uses a clear plastic film for material deposition. The first type of machine uses ink-jet style spray nozzles to spray or “print” to selected locations on the build surface. After the photo-sensitive polymer is sprayed onto the build surface it is then cured using the appropriate light source which is usually ultraviolet light provided by a UV diode that travels with the print head and passes over the freshly sprayed resin. The UV light causes the cross-linking process to occur in the epoxy resin. The second type of machine uses a clear plastic film to provide an even layer of resin that is then put into contact with the build surface and then the new layer is exposed to light using some type of mask that allows only a portion of the new layer to be exposed to the light. Only the exposed resin is cross-linked and becomes part of the object. After the cross-linking has been done, the plastic film is removed which removes all of the non-cross-linked resin.

The only material placement in the X-Y plane for category B machines occurs where the “print head” or plastic sheet is depositing material and no other activity can take place in the build envelop until the material deposition process has completed. Once the build process has been completed then, the build platform is lowered (or raised) one layer and the process is repeated.

In all of the current techniques, no significant production activity can occur when the build platform is being lowered. For systems that build on a surface in the X-Y plane, no production activities can occur above or on the build surface in parallel to either/or the material deposition or material binding process. None of the existing systems that use the X-Y plane build surface can use multiple materials at the same time. Further, even when they use multiple materials—at different times—such techniques can only use similar materials.

Cross-linked Polymerization Ink-jet Printers: In the case of all of ink-jet deposition epoxy resins, the deposition of the new material can only be done in a small area localized to the x-y location of the “print head”. There is also a limit on the rate at which the print head can be moved over the print area because as the deposition rate increases, the size of the print head must be increased to be able to supply more material. With the increased size of the print head, there is an increase in the size of all of the associated hardware including the stepper motors that move the head and feed material into the print heads. The increased hardware size results in an increase in the cost of the machines. There is a limit on how fast the material can be moved in the x-y direction before the total velocity of the material causes distortions in the built surface and the lay-down speed is limited because the UV diodes are normally mounted along with the print head and if the travel rate is too high, then the resin does not have significant enough of exposure to the light to be properly cured. This can be offset by total volume exposure as opposed to localized exposure, however, total volume exposure also introduces other problems into the build process which is why localized exposure is preferred. Further, although multiple materials can be used in a build, the materials are limited to cross-linkable polymers that can be sprayed onto the build surface. No other processes can be used in this type of printer. Because of the method of creating the parts, the parts must be post-processed before they can be used or combined with other parts to form a system. Post-processing usually includes removal of excess resin by washing in a chemical bath and/or additional time in a UV/light bath for final curing and the removal of support structures.

Fused Deposition Printers: As in the Cross-linked Polymerization Ink-jet Printers for all fused deposition plastics the deposition of the new material can only be done in a small area localized to the x-y location of the “print head”. There is a limit to the rate at which the print head can be moved over the print area. As the deposition rate increases, the size of the print (extruder) head increases and along with it the size of all of the associated hardware including the extruder, the heating element in the extruder, and the stepper motors that move the head and feed plastic into the extruder. The increased hardware size results in an increase in the cost of the machines. There is a limit to how fast the material can be moved in the x-y direction before the total velocity of the material causes distortions in the built surface. These distortions occur because when the plastic is extruded from the head it is a liquid and if the print speed is too high then when the plastic hits the build surface it will distort on impact much like when water with a high relative velocity is sprayed on a surface. Another disadvantage to this process is that only one material can be used at a time. Although multiple materials can be used during a build, only one material can be deposited at a time and then the machine has to change to a new material and then it builds using the new material. Each time a different material is used in the build, a material change has to be done. A significant disadvantage to this process is that only fused deposition materials can be used and there is a significant post-processing effort to remove support structures when they are used.

Laser Sintered Plastic and Metal Printers: In the case of the laser sintered powders (metal and plastic), no fusing process can be done until layer deposition is completed and fusing can only be done from above the surface. There are severe limitations on the powder deposition speeds. Powder delivery is normally done using some type of gravity fed hopper with a simple metal bar extended across the length of the Y-axis that spreads powder in the x-direction across the entire build surface. If the spreader bar moves too fast it will not be possible to achieve consistent and adequate powder distribution over the entire build plane. Another disadvantage of the spreader system is that only one type of material can be used when building a part.

Cross-linked Polymerization SLA Printers: Once again, no significant production activity can occur when the build platform is being lowered. Only one type of material can be used in a build and there is a significant post-processing cleanup required before the part can be either fully cured (if required) or used.

Rotating Cylindrical Surface Printers: The rotating cylindrical build surface can only be used for fused deposition and cross-linked polymerization processes. It cannot be used with powder based processes. No significant production activity can occur when the build platform is being lowered. The production speeds that can be achieved with this method are limited by the location of the center of mass of the object being built, the density of the material being used, and the stiffness of the axis of rotation. The initial build surface, minimum required dimensions and stiffness have a significant effect on the end product.

Rotating Build Plate Printers: The rotating build plate is an alteration to the standard rectangular build plate typically used in X-Y plane printers. The rotating build plate can be used with existing machines that build in the traditional X-Y plane sliced layer method. For powder deposition systems, the purpose of the rotating build plate is to rotate the layer under construction so that an optimal orientation of the layer to be built can be obtained. By orienting the part so that the layer to be built is on the optimal orientation, the amount of powder required to properly coat the surface of the build plate is reduced and this reduces the amount of friction between the re-coater arm and the build plate. As in the typical rectangular build plate, the round build plate is still moved in a step-wise manner in the z direction after the laser has finished forming the exposed layer and then the re-coater arm moves in the X-Y plane across the entire build plate after the build has been lowered by one layer thickness. The rotational build plate can also be implemented with the fused deposition modeling and other techniques but if the build is still in the X-Y plane and the build plate is moved in a step-wise manner in the z direction, then the process is still intermittent and the time delays associated with the traditional X-Y plane method still apply.

Continuous Feed 3D printers that use the Helical Build Surface manufacturer 3D parts and assemblies by using one or more fixed material deposition systems known as a material deposition “line” that is suspended above a rotating build platform and extends from the center of the build platform to the radius of the platform. The material deposition source deposits along a deposition line. Simultaneously as the platform rotates, material is deposited build platform where the freshly deposited material is fused at the build line by a fusion source. The build line remains in the x-y plane while the build platform is able to travel in the z-direction. The line that extends from the center of the build platform to the radius of the platform along which material is fused is called the fusion line.

This type of printer can have more than one material deposition line and the corresponding fusion line and can employ more than one type of material deposition and fusion processes simultaneously. A machine with one deposition/fusion line is said to be a single-flute machine. A machine with three deposition/fusion lines is said to be a three flute machine. With this type of machine a flute may have more than one type of material deposition and fusion process and the same applies to machines with multiple flutes.

With this type of machine the number of flutes is limited by the geometry deposition/fusion process. Typical with this type of machine each flute has a single material fusion system. For example, if the material fusion is performed with a laser, then a single laser is used along each fusion line. In a three-flute machine each flute would have a separate laser that is dedicated to each fusion line associated with each flute.

With this type of machine the use of a laser for fusion is typically done using a laser scan head mounted above the build surface at a distance appropriate for the length of the build line. For example, a 250 mm long fusion line requires a focal distance of approximately 330 mm in order to achieve a 50 micron spot size at the surface of the fusion line. When considering the physical size of the lenses and scan heads required to achieve a 250 mm long build line, a limit of four or five flutes is the maximum that can be achieved using a single laser on each build line.

### SUMMARY OF THE INVENTION

One implementation relates to an apparatus for the forming of three-dimensional objects in a single or multi-flute helical build machine and consists of having multiple fusion sources for each fusion line for each flute.

In one implementation a material deposition line and a fusion line are along the same line because the material fuses as it is deposited and in this case multiple material deposition sources are mounted on a linear translation system that travels back and forth along a material deposition line that extends from the center of the build platform to the radius. The distance traveled is such that each material deposition source covers an equal distance along a deposition line and the entire length of the line is covered by one of the deposition sources.

In one implementation the fusion source is a laser that operates by focusing the beam from either the side of the build platform or from above the build platform by using a series of mirrors that direct the beam through one or more lenses that are mounted on a linear translation apparatus that moves the lens or lenses back and forth along a fusion line for a fixed distance in a direction that extends from platform to the build radius. The distance traveled by the lenses is such that the focal point of each lens travels a distance along a fusion line and the entire length of a fusion line is covered by the focal point of one of the lenses. A laser beam is associated with each lens so that each area along the fusion line can be fused separately from the areas covered by the other lasers and lenses. The lenses are mounted at a distance above the fusion line as appropriate for the desired focal point size of the machine process.

In one implementation the fusion source is a laser beam or laser beams that operates by using a motor driven mirror system to direct a collimated beam or beams of energy to a series of lenses that are fixed along the build line.

In one implementation the material deposition system is with multiple ink-jet style print heads which are mounted on a linear translation system with the print line of the inkjet heads aligned with a fixed geometry in relation to the orientation of a deposition line. A linear translation system moves the print heads back and forth along a deposition line that extends from the center of the build platform to the radius the entire length of the deposition line can have material deposited on it by one or more of the print heads.

Additional features, advantages, and embodiments of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a schematic drawing of the front view of an embodiment of a device for manufacturing 3D objects and systems using the Helical Build Surface process.

FIG. 2 is a schematic of a top view of an embodiment of the device in FIG. 1.

FIG. 3 is a schematic of a detailed view of a moving multiple laser fusion source device referenced in FIG. 1 and FIG. 2.

FIG. 4 illustrates an implementation of a build plate, which is shown in the implementation as a flat, round disk.

FIG. 5 illustrates one implementation of a helical surface following one rotation.

FIG. 6 illustrates an implementation having multiple layers of a helical surface with build material applied across the entire surface (no hole in the center).

FIG. 7 illustrates an implementation of a helical surface on top of a build plate.

FIG. 8 illustrates an implementation of an example “widget” that may be built by the proposed device.

FIG. 9 illustrates an implementation of an example of the widget as formed by helical layers using the proposed build techniques.

FIG. 10 illustrates an implementation where the single layer of the helical surface from FIG. 5 that has been divided into sections for the purpose of the fusing process. The “wedges” or sections shown in the figure are greatly exaggerated in size for the purpose of visualizing the build process.

FIG. 11 illustrates an implementation where the single layer of the helical surface from FIG. 10 that has been divided into sub-sections for the purpose of the fusing process where different materials are used and the sub-sections represent possible material differences. The “wedges” or sections and sub-sections shown in the figure are greatly exaggerated in size for the purpose of visualizing the build process.

FIG. 12 illustrates the overall flow of the build process from part design to post-processing.

FIG. 13 is a schematic drawing of the front view of an embodiment of a device for manufacturing 3D objects and systems using the Helical Build Surface process.

FIG. 14 is a schematic of a top view of an embodiment of the device in FIG. 13.

FIG. 15 is a schematic of a detailed view of a moving multiple laser fusion source device referenced in FIG. 13 and FIG. 14.

FIG. 16 is a schematic of a detailed view of a fixed multiple laser fusion source device referenced in FIG. 13 and FIG. 14.

FIG. 17 is a schematic of a detailed view of a moving multiple combination deposition/fusion source device referenced in FIG. 13 and FIG. 14.

FIG. 18 is a schematic of a detailed view of a moving multiple ink-jet print head type of deposition/fusion source device referenced in FIG. 13 and FIG. 14.

FIG. 19 illustrates a computer system for use with certain implementations.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

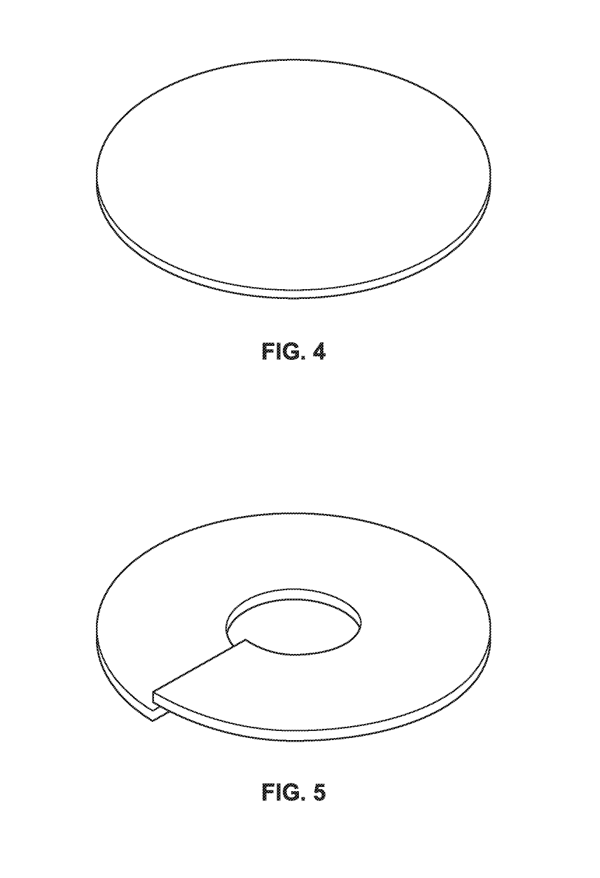

Described herein are methods and an apparatus adapted for improving the speed of production and quality (resolution) of the free-form manufacture of complex systems using multiple three-dimensional (3D) printing techniques on a rotating build deck in combination with the ability to increase the distance between the material source and the build deck so as to allow for the continuous feed manufacturing of 3D objects and complex systems. In one embodiment, continuous rotation of the build deck in combination with the continuous Z-axis motion of the build deck results in the deposition of a continuously forming helically shaped layer that folds back onto previously deposited sections of the helix and thereby forms a 3D object or system of objects. The build deck, or build plate, is shown in FIG. 4. The figure is for conceptual understanding only and for real applications the shape of the build plate will be determined by the requirements of the build. A single rotation of the helical surface is shown in FIG. 5.

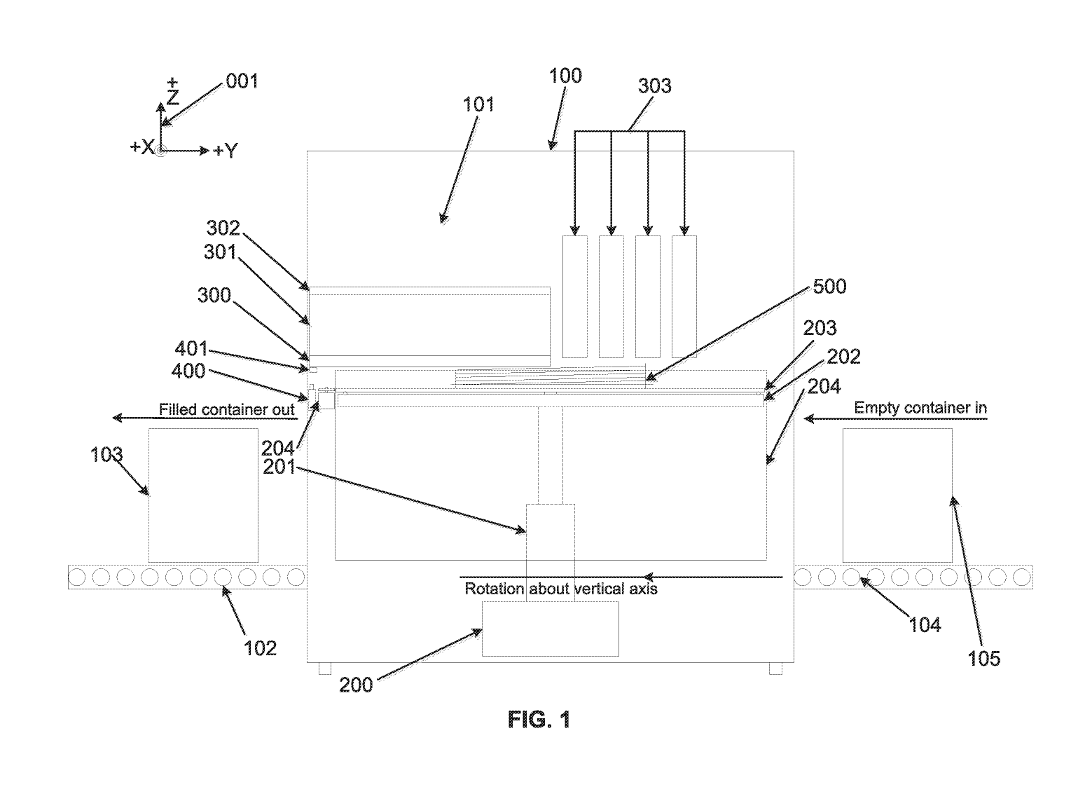

FIG. 1 illustrates an embodiment of material deposition 300 for depositing a single material of equal layer thickness across all or a portion of the entire build surface extending from the center of rotation to the perimeter of the build surface. Other embodiments of the material deposition system 300 may include the ability to selectively deposit multiple materials in parallel along all or a portion of the line across the build surface that is formed by the material deposition system that extends from the center of rotation to the perimeter of the build surface.

FIG. 5 is for conceptual understanding only and in a real application the surface may not be a flat helix but may be shaped as required for the build. The hole that is shown in the center of the helix is exaggerated for visual effects so that the observer can better understand the shape of the surface. In a real application, materials may be applied in such a way that no hole exists in the center of the build.

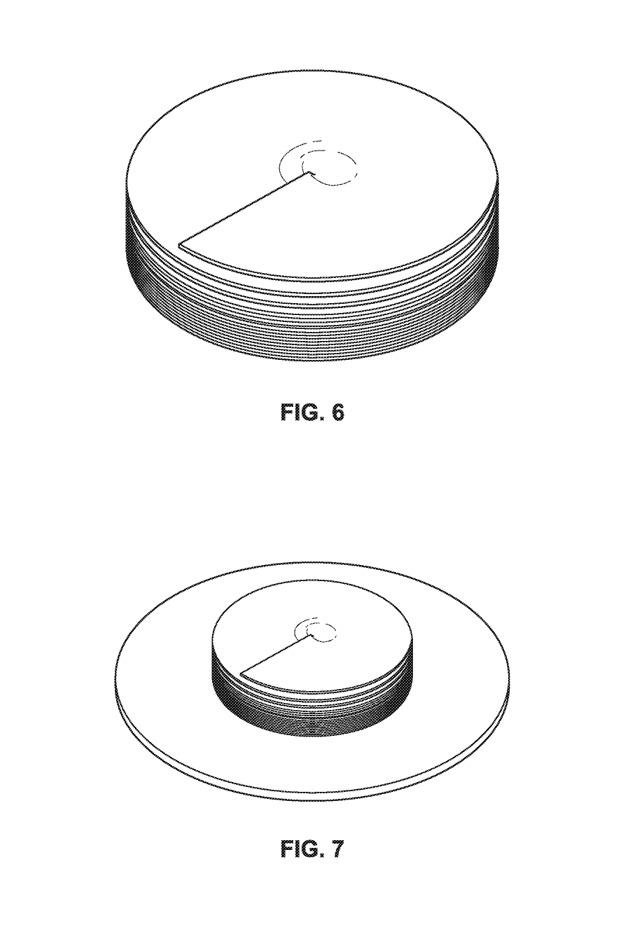

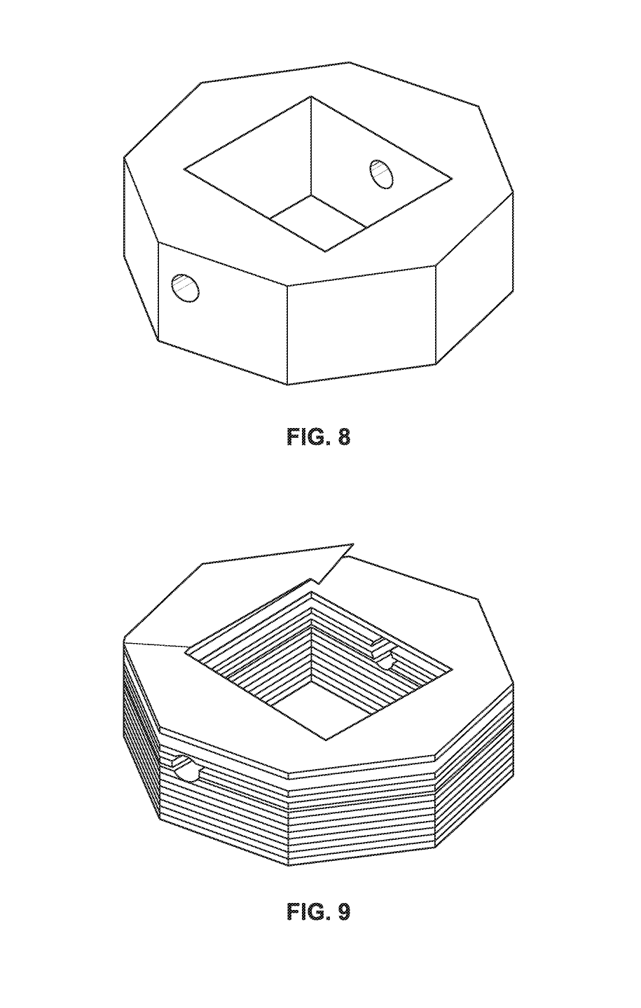

FIG. 6 shows multiple layers of a helical surface and FIG. 7 shows multiple layers of a helical surface that have been deposited or built on a build plate. With regard to FIG. 6, the top four layers in the figure have a greater pitch than the bottom layers to demonstrate that the surfaces are in fact helical. This figure is for conceptual understanding only and in a real application the surface may be shaped differently as required by the build.

In one implementation, systems and methods are provided relating to a 3-D printing device and technique that utilizes a rotating build deck and that allows for a change of where the material deposition occurs. In one embodiment, the surface rotates while material is continuously deposited on the build deck and simultaneously the build deck is moved away from the material source or sources. The deposition of the material along the build line or build lines occurs along the entire radius of the build plate in a simultaneous and continuous manner. Continuous means that the system is always operational and available to deposit material but it does not necessarily mean that it will always deposit material. Material will be deposited as required by the object(s) being made and the type(s) of materials being used. The motion of the build deck around the Z-axis automatically provides for new surface area for material deposition from sources that may be fixed in place or have limited mobility. While a layer of material is being deposited, the distance between the build deck and the material source increases at a continuous or near continuous rate such that new material may be deposited on top of previously deposited material as the build plate completes each rotation. The Z-axis motion, both the linear adjustments and the rotational motion, of the build deck may be obtained with either direct drive DC motors, brushless DC motors, DC stepper motors, or A/C motors controlled by a variable frequency drive and where the displacement is applied to achieve one or more layer thicknesses of displacement in the Z-axis direction.

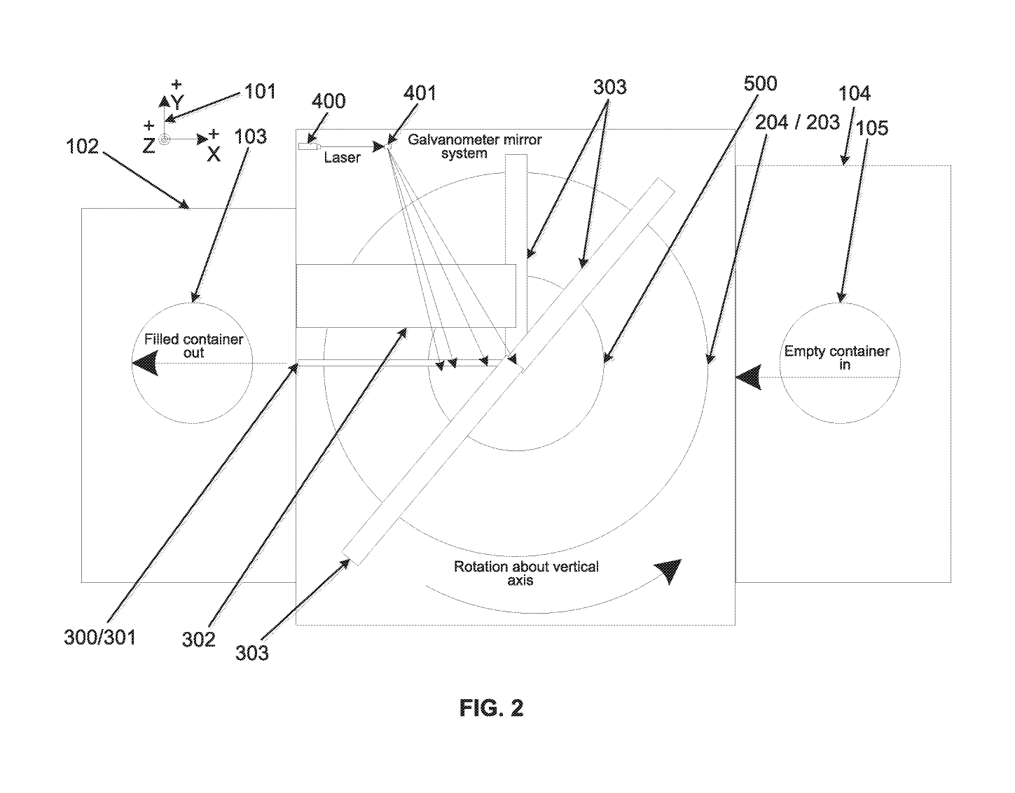

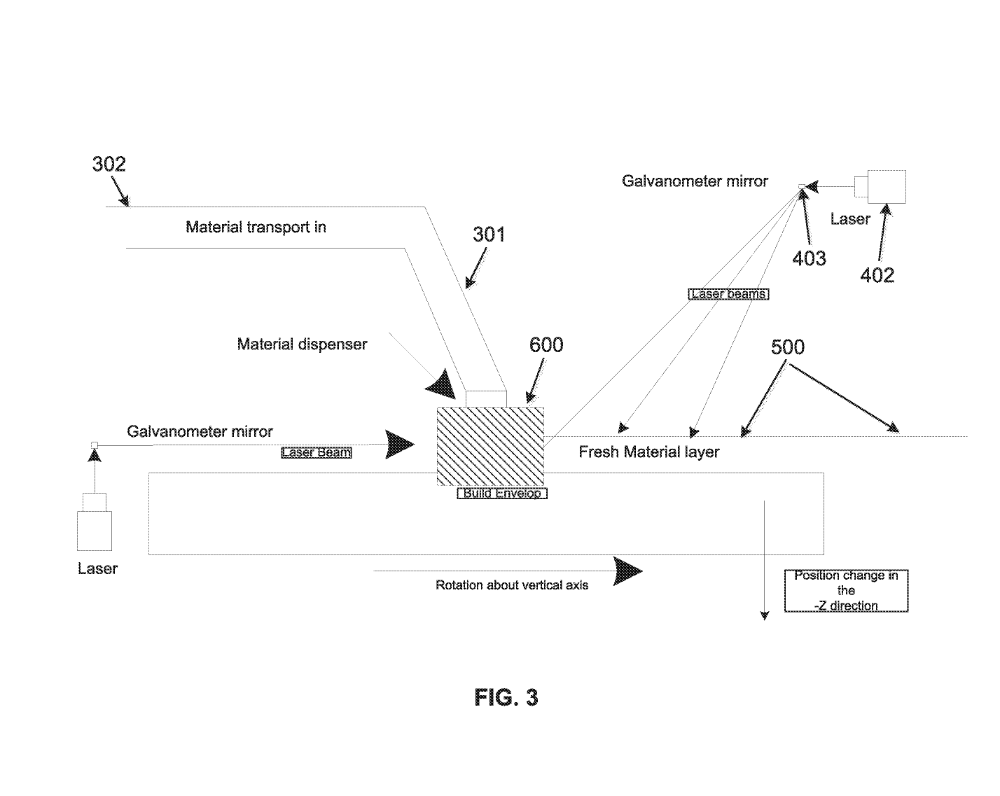

Certain embodiments of the invention relate to devices adapted to build complex systems using 3D printing in combination with previously manufactured parts stocked within the machine to build complex 3D objects using multiple additive and or subtractive manufacturing processes. FIG. 1 is a schematic of a front view of one embodiment of the apparatus 100 for making a solid object 500. FIG. 2 is a top view of the embodiment of the device shown in FIG. 1. FIG. 3 is a close-up of the schematic of the material handling system shown in FIGS. 1 and 2. The device may include an outer casing as appropriate to safely contain the processes used within. One embodiment of the device can be described in Cartesian coordinates 001. The 3D space of the build environment is described by a 3D Cartesian coordinate system where the +Z-axis points up. Following this definition of the coordinate system the X-Y plane defines the orientation of the horizontal surface and the Z-axis is the axis of rotation with +Z pointing up. The apparatus 100 consists of a build chamber 101 and which contains a rotating, in one embodiment circular, region that serves as a build container 202. In one embodiment, the build chamber is generally as is typical with 3D printers. It should be appreciated that the build chamber can be scaled as required for the types of products the machine will produce. In various implementation the systems and methods can be scaled up (or down) to accommodate the creation of large (or small) objects. For example, in one implementation on-demand factories are provided that can make cars, trucks, etc. Another implementation is configured as smaller units that people have in their homes for personal manufacturing. Certainly a large assembly line style unit could be made that manufactures large quantities of consumer goods in a fashion similar to today's factories that use cast or molded parts that are then assembled. The rotating build platform does not have to be just a disk but could be employed as rotating ring or conveyor belt type of arrangement.

The types of products may vary with specifics of the printer. In one implementation, the printer may employ laser sintering of metal powders. Current metal printers use a 2D and 3D scanner which is basically two rotating mirrors combined with a lens that focuses the laser beam. This arrangement has some limitations due to the limitations of a lens' ability to focus a beam of light within a certain range of rotation of the mirrors in the scanner. In some implementations, since the surface moves then a 1D galvanometer can be used to move the beam and a linear fixed reflector can be employed that both directs the beam onto the target line and also focuses the beam to a finer beam width than what can be achieved with a 2D or 3D scanner. This approach is believed to lead to better quality surface finishes and may eliminate the need for post-build machining as is currently done. For example, FIG. 2 illustrates the use of a Galvanometer mirror system.

In one embodiment, the build chamber encloses a rotatable build surface. In one embodiment, the rotatable build deck rotates about the Z-axis and is movable in the Z direction. In a further embodiment, the build deck is a disk and in yet a further embodiment, the build deck rotates constantly during a build.

The build chamber also includes one or many material deposition sources which can continuously feed material to the build deck. In one embodiment, the material deposition sources are oriented in an X-Y plane above the rotating disk and are oriented along a line which is somewhat perpendicular to the axis of rotation. The material sources do not have to be fixed in place and could be moved around as needed by the process. In one implementation, during a build they are fixed and the build surface moves. As the surface of the build deck, which is rotating, passes below the material sources, a fresh layer of material is deposited on the build deck. There may be one or many sources of material simultaneously depositing material on the surface as it passes below the material deposition sources. The freshly deposited material in combination with the rotating surface, which is capable of moving in the −Z direction, forms a helical build surface upon which subsequent materials and layers are deposited. It should be noted that a single material deposition source may deposit multiple materials in parallel across the deposition line and may also deposition multiple materials in series at any or all points across the deposition line.

The build chamber includes one or more material sources and incorporates one or more fusion processes, such as but not limited to cooling of melted/extruded material, cooling of laser melted material, laser cross-linking of photo-sensitive polymers, or UV-curing of photo-sensitive polymers that have been target deposited or target cured, vapor deposition, chemical vapor deposition, electroplating, or other material deposition techniques. Current systems typically use one fusion process. In one implementation, two or more processes may be used in parallel and/or sequential application. For example, the system may extrude a melted polymer and then spray deposit a photo-sensitive polymer on the edge of the extruded plastic. In another example, the system may laser sinter a metal powder, vacuum the un-lasered powder and then spray coat the edge with a photo-sensitive polymer as an edge treatment. The build deck includes a helical surface. The pitch can vary depending on what is being made and the process or processes being used. In one implementation, the thickness of the material defines the pitch of the helix if one material layer is deposited during one turn. If more than one layer is deposited per revolution then the pitch would be the sum of the thicknesses of the layers deposited. As the exposed helical surface traverses around the axis of rotation, i.e. the Z-axis, there is opportunity to employ more than one material deposition mechanism and more than one material source. The planer surface of prior systems does not allow more than one layer of material to be deposited because the material deposition mechanisms move in a plane just above the deposition plane and two material deposition mechanisms cannot move in the same plane at the same time. If a second mechanism was added it would have to travel above the first. For powder systems this would not work since the first layer has to be melted before the second layer gets deposited. For other deposition mechanisms the print head for a second mechanism would have to travel in the same plane as the print head for the first layer and would add the additional complexity of knowing the location of the x-y carriage and print head of the first layer mechanism and implementing collision avoidance control which would diminish the effectiveness of the second layer.

In one implementation, a rotating disk moves in the z-direction in a stepwise motion and with such an implementation additional layers can be added in a single turn. However, the system must account for the issue of the first layer overshooting the first material deposition source for the final layer to fully rotate past the final layer source. This means that any follow-on layers (2^{nd}, 3^{rd}, etc.) would be higher than the bottom of the first material deposition source and the system would have to be able to lift all of the material sources except the final layer. The material deposition sources are oriented in the X-Y plane in a radial direction extending from the center of rotation to the perimeter of the rotating cylinder.

The build container 204 may have a build deck 203 having a flat disk bottom that is used as a build deck and which can be raised and lowered with a lift system 200 in the Z axis direction. The build container 204 may also provide a build deck support mechanism 202 that supports the build deck and a separate build deck rotation mechanism 204 that rotates the build deck about the axis of rotation and for moving the build container 204 in a way that is separately controlled from the Z-axis movement of the build deck 203 in such a way that as material is dispensed from the material deposition unit 300 and it is deposited on the build deck. The combined rotational and translational motion causes the deposition of material to form a helical surface on the top of the build surface. As the build surface continues to rotate and as material continues to be deposited, a 3D object is formed by the continuous helical shaped layer of material as the helix folds down onto previous threads in the helix.

In one embodiment, the build deck requires more than just a rotating flat plate for material deposition and must include a build container. In one embodiment, the build container may consist of a rotating circular cylinder that contains the build deck and as the build plate rotates the build deck lowers into the build container which is also rotating.

Another embodiment of the build container may consist of a circular disk where the outside wall of the build container is manufactured during the build process and when a build container is full or the build is complete. The next build container is manufactured with an initial start of the build where the circular disk is manufactured before continuing with the production run. For implementations utilizing multiple materials and that can operate in a continuous mode, if the build container is manufactured along with the product, then a cheaper material than the build material could be used to manufacture the build container. This leads to the concept that in a manufacturing-on demand operation, the customer could go to a web store, place an order and the shipping container is manufactured around the object purchased.

In one embodiment, the rotational motion is induced by an electric motor 204 that is connected to the rotatable build deck 203 by way of a gear system. In other embodiments, the motor 204 may be coupled with a wheel that engages the edge of the rotational surface with friction. Another embodiment would have a motor where the shaft of the motor engages directly with the build deck 203 in such a way as to provide direct drive coupling.

One embodiment of the material deposition system is a single powder deposition system that has a material supply 300, a material feed mechanism 301 and supply pipeline 302 to a material supply that is external to the build chamber. The material deposited by this system 300 is fused with an energy source that can be located either above 410 or to the side 400 of the line formed by the material as it is deposited on the build deck 203. Included with the energy source (such as a laser) is a targeting system 401, for example but not limited to a galvanometer mirror, which is used to selectively target the material that is to be fused. In other embodiments, the laser could be located above the build deck 203 only. In other embodiments of the device using other material deposition systems, the energy source may be one appropriate for the material being used, such as for melting plastic or powder or curing photo-sensitive resins. As with the described laser, such alternative forms of an energy source may be used instead of a laser and may be located above the build deck 203, above the build envelop, or to the side of the build surface or to the side of the build envelop and could fuse the material as it is deposited on the build surface. More than one material deposition system and fusing system may be used at the same time either in parallel or in series to deliver the material as required to build the object or objects. In addition, different materials and different energy sources may be utilized within the same build container.

The material deposition system 300 can be considered a material handling system whose function is to deposit material. In other embodiments the material handling system or systems 303 may be material deposition systems that add additional layers in series with the first system 300 or they may be material handling systems that selectively remove material using typical subtractive manufacturing techniques such as milling, drilling, thread tapping, cutting, grinding, polishing, etc., using live tooling designed for the particular embodiment of the machine. Other embodiments of the material handling systems may include chemical process such as etching, electroplating, specialized surface treatments, etc. as required for the particular embodiment of the machine. Other embodiments of the machine may have material handling systems that retrieve externally manufactured components and inserts them at the appropriate time into the build process such as could be done with a robotic pick and place system only adapted for the particular embodiment of the machine.

The material that is placed on the top surface of the object being built 500 forms a helical shaped surface that functions as the build surface upon which a fresh layer or layers of material is deposited as the moving surface both rotates about a fixed axis and is simultaneously displaced away from the material sources along the axis of rotation of the build surface. In other embodiments of the device, an intermediate surface which is helically shaped may be used as the build surface where a thin foil of the deposited material is formed in a selectively fused manner and which is then moved across the helical surface and then deposited on the rotating helical shape top of the build platform where it is then selectively fused with the previously deposited layers. Other embodiments of the intermediate build surface may be used. The purpose of the intermediate surface is to avoid using support materials whenever possible during the build process.

In all configurations, the full build container will have to be removed and the mechanism used will be matched to the types of products a particular embodiment is designed to produce.

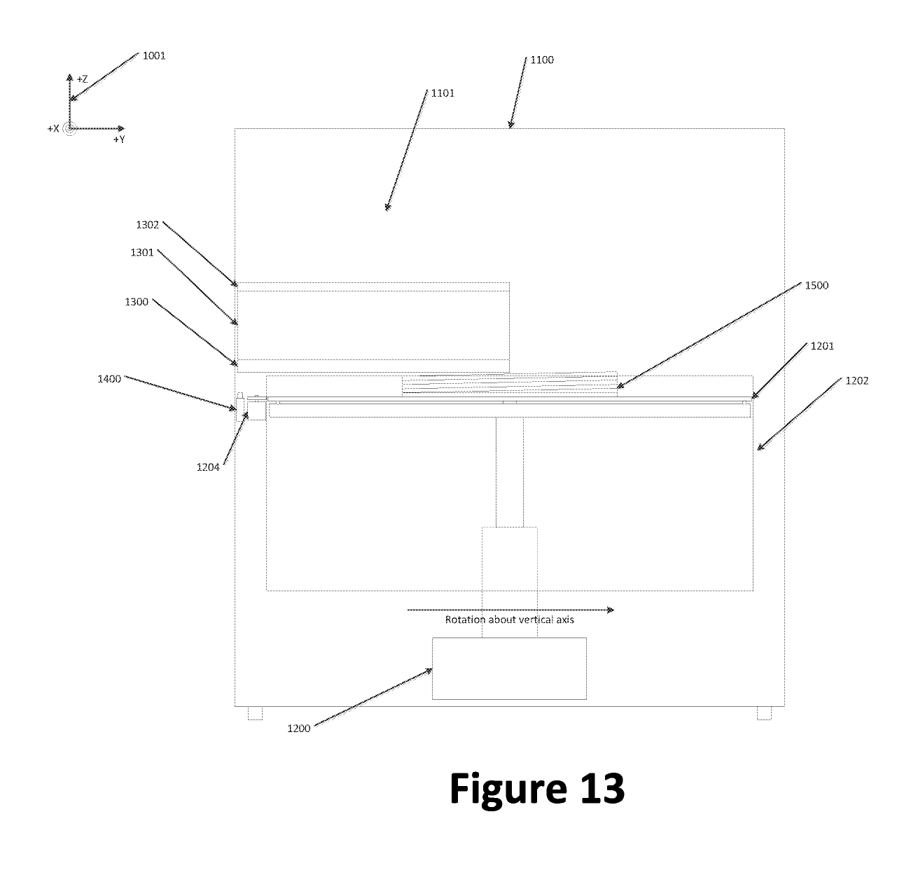

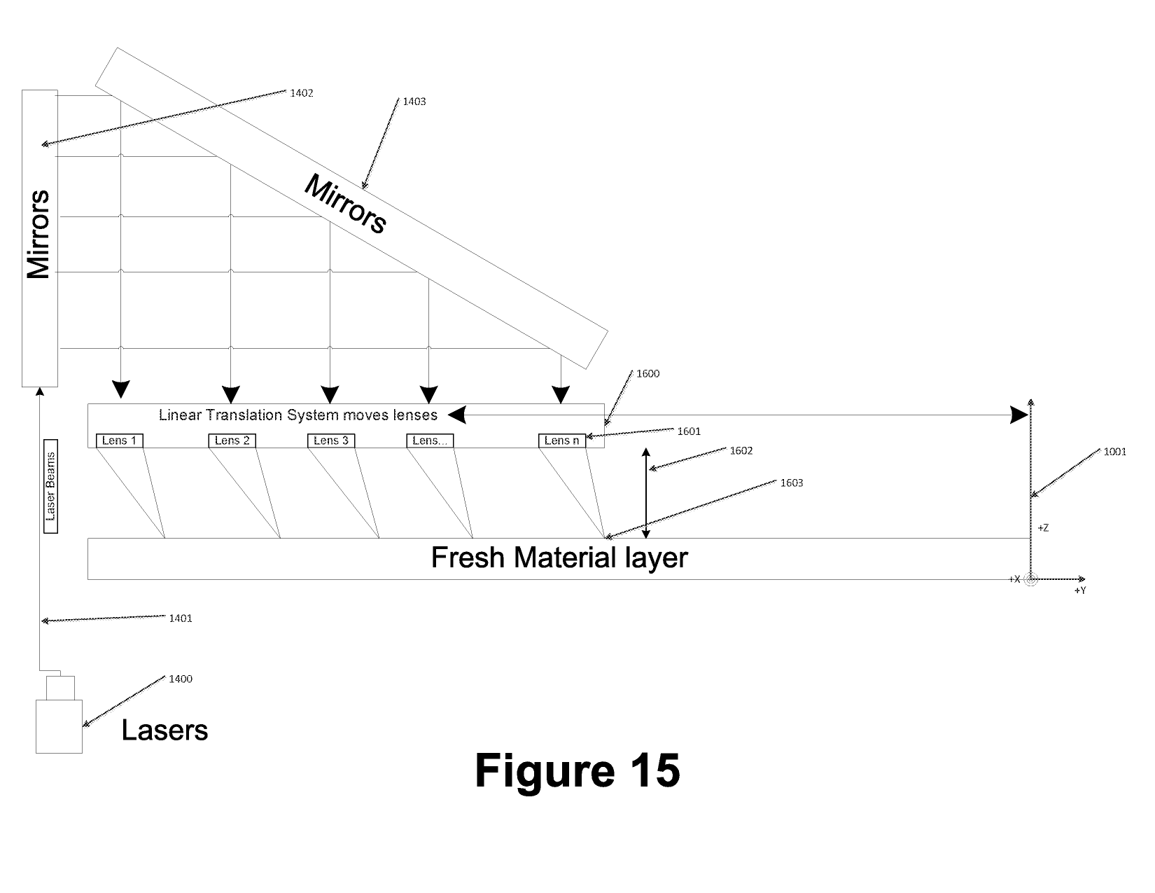

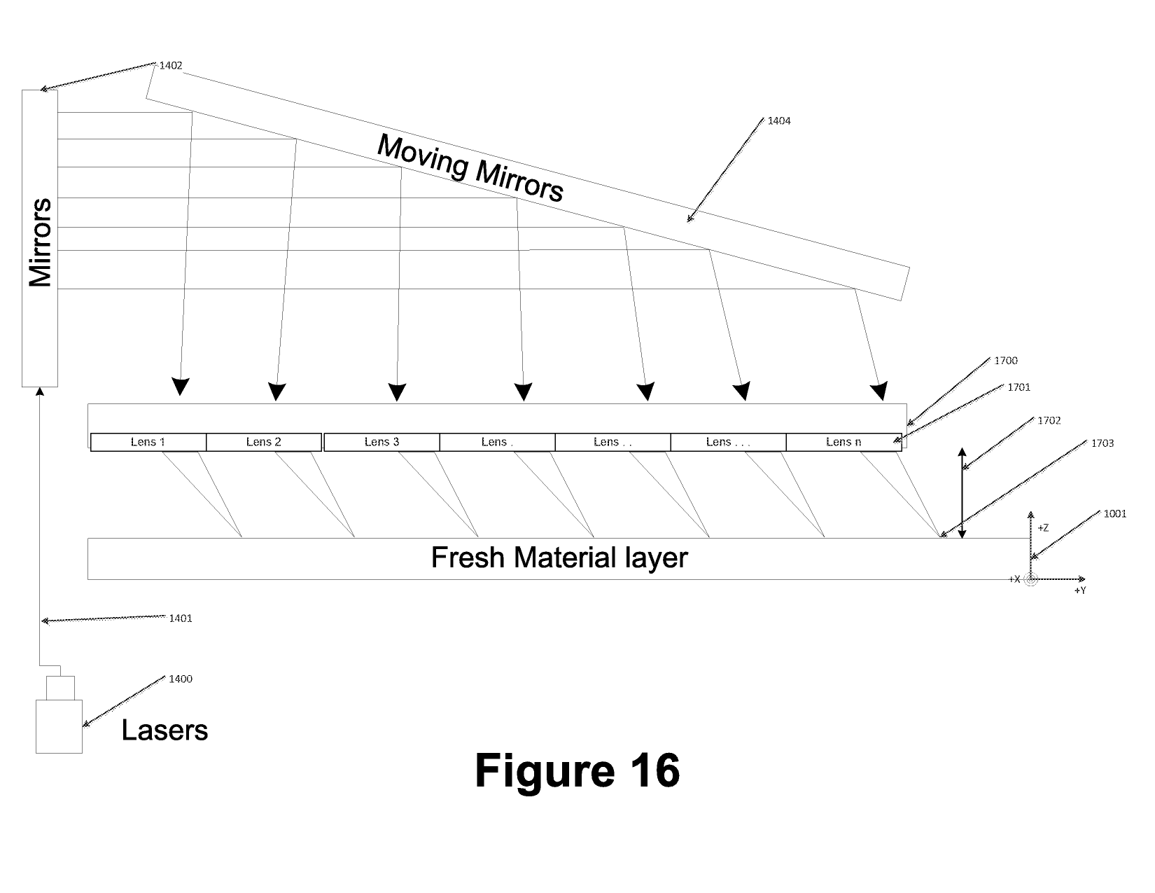

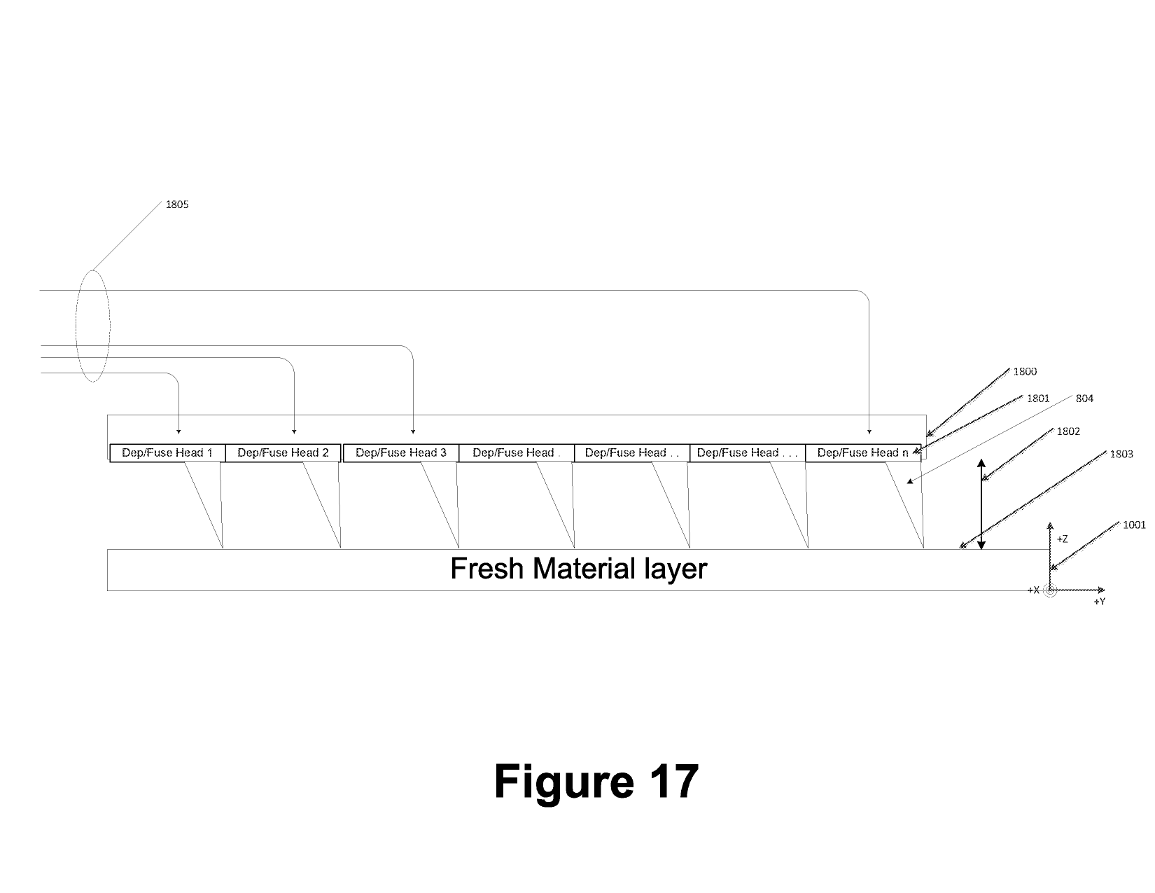

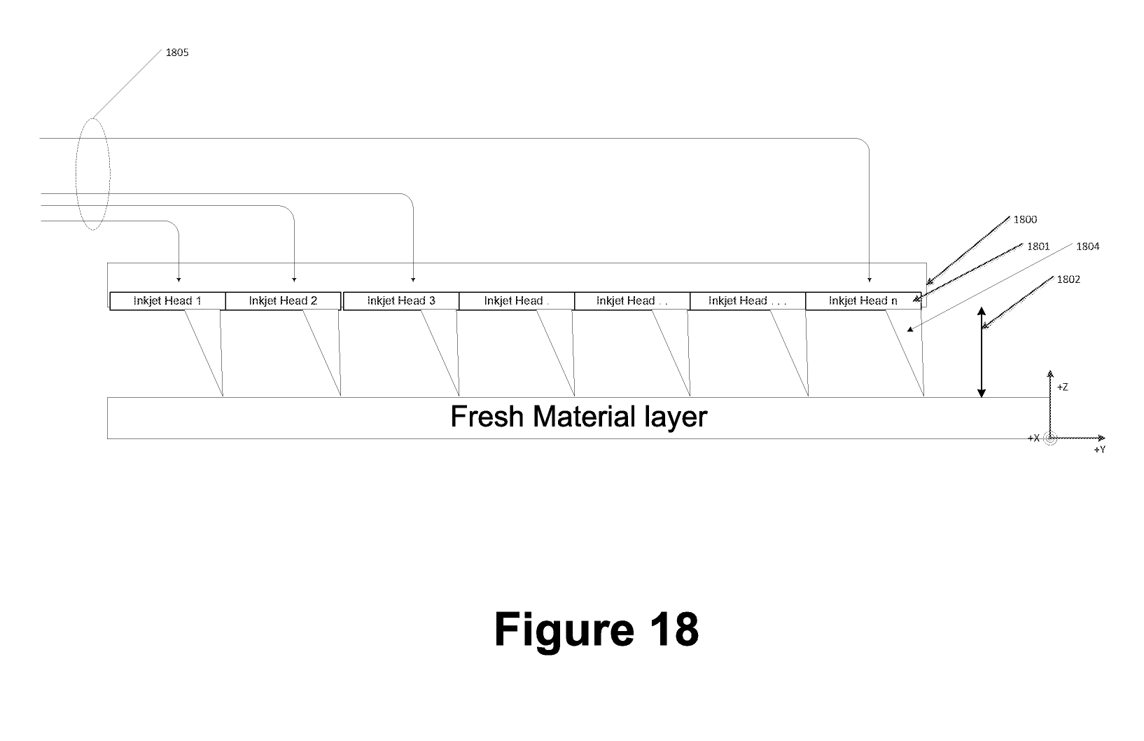

Another embodiment is illustrated in FIG. 13, which depicts a schematic of a machine that manufactures parts using the 3D printing techniques and follows the helical build surface process. 1001 is the general orientation of the xyz axis and in a helical build machine the Z-axis is aligned along the center of rotation as defined by the Z-axis support mechanism, 1200. In the helical build machine process the build platform or build deck, 1201 is supported by the Z-axis movement mechanism, 1200, and rotates about the Z-axis. 1300 is the material deposition system which includes the material feed mechanism, 1301, and the material feed pipeline, 1302. The platform, 1201, and when fused the material forms the 3D object being manufactured, 1500. In a laser based fusion system, the laser source, 1400, is located as appropriate in the machine and the laser beam or beams are delivered by the appropriate means as detailed in FIG. 15 and FIG. 16. If the material deposition and fusion system uses a material that fuses as it is deposited, the fusion mechanism is detailed in FIG. 17. FIG. 18 details an ink-jet style deposition/fusion system.

For embodiments using a laser or lasers as the fusion system, collimated lasers set of fixed mirrors that direct the beam(s) to a set of lenses that are mounted on a translation stage that moves the lenses relative to the fusion line and directs collimated laser beams to the fusion line. In another embodiment, the plurality of fusion sources are collimated lasers coupled with a set of fixed mirrors that direct the beams to a set of rotating mirrors that then direct collimated laser beams to a set of fixed-in-place lenses that focus the collimated laser beams onto the deposited While the fusion system is generally described herein with regard to a laser as an example, it should be appreciated that other fusion systems may be used. For example the fusion source may be electric arcs or ionized plasma gas. The fusion source may be located on a translation stage that moves back and forth along the fusion line. The fusion line and fusion source are fixed relative to the rotating build stage (and object being built).

While the materials deposition source is generally described herein with regard to an ink-jet system, it should be appreciated that other materials deposition sources may be used, include an extrusion system or a wire feed mechanism. The deposition source may utilize multiple flutes to dispense materials. Further, multiple heads or individual sources (e.g., extrusion heads, wire-feed heads, ionic deposition heads, CVD heads, etc.) may be located on the materials deposition source, including organized into groups within multiple flutes. The deposition source may be located on a carriage that moves back and forth along the deposition line. The deposition line and deposition source are fixed relative to the rotating build stage (and object being built). In one embodiment where the deposition line and fusion line are co-located, the deposition source and fusion source may be positioned on the same movable carriage or translation stage or separate.

Further, as described in greater detail below, some embodiments include a plurality of fusion lines and/or a plurality of deposition lines

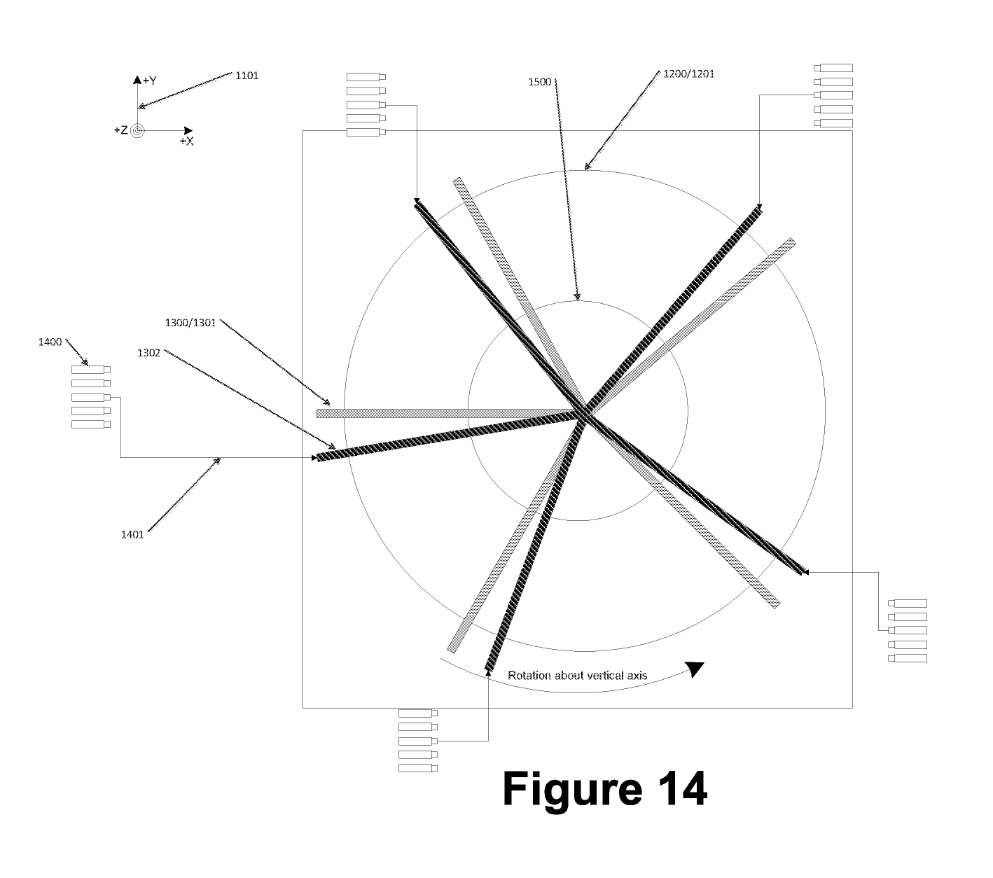

FIG. 14 is a schematic showing the top view of a helical build machine as shown in FIG. 13. The machine in FIG. 14 is a five-flute machine and can manufacture five separate helical surfaces simultaneously. 1300 is a material deposition and fusion system that has five material deposition lines, 1301, and five material fusion lines, 1302. For machines that deposit and fuse in one step, 1301 is both the deposition and fusion line. In one implementation the material deposition is powder and the fusion method is with a laser or lasers, 1400, in combination with a beam delivery system, 1401. One implementation uses multiple lasers along each fusion line. If four lasers were used simultaneously on the five fusion lines shown in FIG. 14, the machine would be 20× as fast as a single-flute machine that uses a single laser.

FIG. 15 is a schematic showing a fusion line, 302, from FIG. 14 that uses a multiple laser sources, 1400, and a multiple beam delivery system, 1401, 1402 and 1403, to deliver the beams to a series of lens that are supported on a moving linear translation system, 1600. The mirror delivery system has fixed mirrors on the side of the build platform, 1402, that direct the laser beams to the mirrors, 1403, that direct the beams to the focusing lenses 1601. The mirrors, 1403, that direct the beams into the focusing lens are attached to the linear translation stage and they move with the lenses. 1602 is the focal length of the lenses that are mounted on the translation stage and the focal length is determined by the design of the machine. For example, the focal length of the lenses can be reduced from the current typical 330 mm to 30 mm while reducing the spot size from 50 microns to 10 microns which increases the effective resolution of the machine. This arrangement allows the spot size to be tuned to match the needs of the machine and expands the applications that the machine can target. This also increases the number of flutes a machine can have. For example, with a 330 mm focal length, the collimated beam that enters the galvanometer must be on the order of 20 mm in diameter. If we reduce the focal length to 30 mm, we can reduce the collimated beam size from 20 mm to 2 mm and maintain the same spot size. A machine that requires a 2 mm diameter collimated beam can have 10 times as many flutes as a machine with a 20 mm collimated beam and it becomes physically possible to have a machine with 20 flutes and five lasers/flute which is a machine that is potentially 100 times faster than a single flute machine.

FIG. 16 is a schematic showing a fusion line, 1302, from FIG. 14 that uses a multiple laser source, 1400, and multiple beam delivery system, 1401, 1402 and 1404, to deliver the beams to a series of lens that are supported on a stationary support system, 1700. The mirror delivery system has fixed mirrors on the side of the build platform, 1402, that direct the laser beams to moving mirrors, 1404, that direct the beams to the focusing lens 1701. The mirrors, 1404, that direct the beams into the focusing lens are driven my motors that direct the beams along the fusion line and that keep each beam on each lens as required by the design of the machine. 1702 is the focal length of the lenses that are mounted on the support system and is determined by the design of the machine. For example, the focal length of the lenses can be reduced from the current typical 330 mm to 30 mm while reducing the spot size from 50 microns to 10 microns which increases the effective resolution of the machine. This arrangement allows the spot size to be tuned to match the needs of the machine and expands the applications that the machine can target. This also increases the number of flutes a machine can have. For example, with a 330 mm focal length, the collimated beam that enters the galvanometer must be on the order of 20 mm in diameter. If we reduce the focal length to 30 mm, we can reduce the collimated beam size from 20 mm to 2 mm and maintain the same spot size. A machine that requires a 2 mm diameter collimated beam can have 10 times as many flutes as a machine with a 20 mm collimated beam and it becomes physically possible to have a machine with 20 flutes and five lasers/flute which is a machine that is potentially 100 times faster than a single flute machine.

FIG. 17 is a schematic showing a combination material deposition and fusion line, 1302, from FIG. 14 that uses multiple deposition and fusion sources, 1801, which are supported on a moving or stationary support system, 1800, to deliver the material onto the build platform where it fuses to form the 3D object, 1803. 1805 is the material transportation system that supplies the material to the deposition/fusion heads, 1801, which deposit the material which is transferred through the deposition path, 1804, and is deposited on the top of the build surface, 1803, where it fuses and forms the 3D object, 1803. 1802 is the distance between the deposition heads and is determined by the requirements. A machine that uses 4 deposition/fusion heads with five flutes is a machine that is potentially 20 times faster than a single flute machine. A combination material deposition/fusion line may consist of extruded plastics or other molten material that solidifies once it lands on the build plate. Other types of material deposition/fusion lines may consist of material that is deposited by using welding techniques such as MIG or TIG or plasma melted metal powders or other deposition techniques such as ionic deposition or chemical vapor deposition.

FIG. 18 is a schematic showing a combination material deposition and fusion line, 1302, from FIG. 14 that uses multiple inkjet deposition sources, 1801, which are supported on a moving or stationary support system, 1800, to deliver the material onto the build platform where it fuses to form the 3D object, 1803. 1805 is the material transportation system that supplies the material to the print heads, 1801, which deposit the material which is transferred through the deposition path, 1804, and is deposited on the top of the build surface, 1803, where it fuses and forms the 3D object, 1803. 1802 is the distance between the inkjet print heads and the top of the build surface and is determined by the requirements of the material and the process. A machine that uses 4 inkjet print heads with five flutes is a machine that is potentially 20 times faster than a single flute machine.

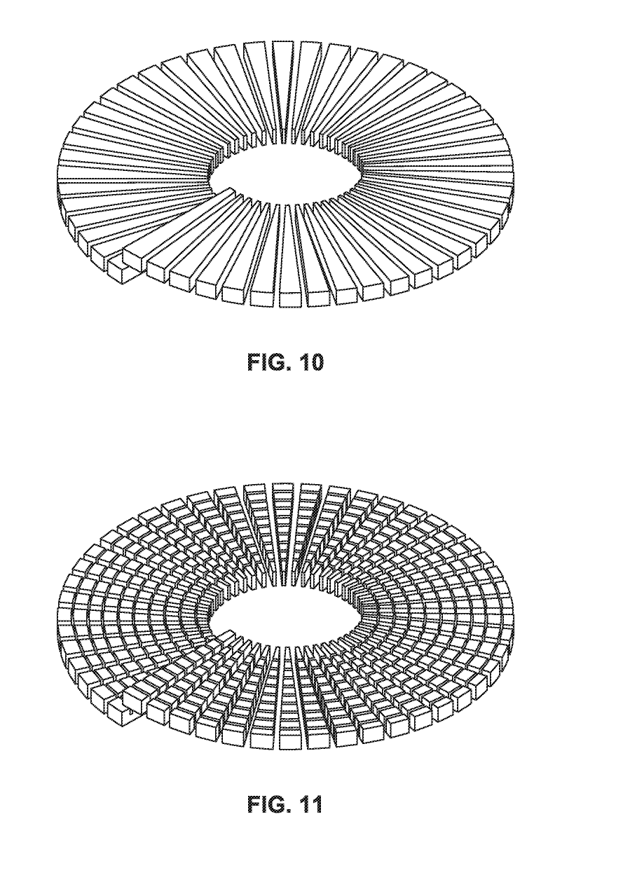

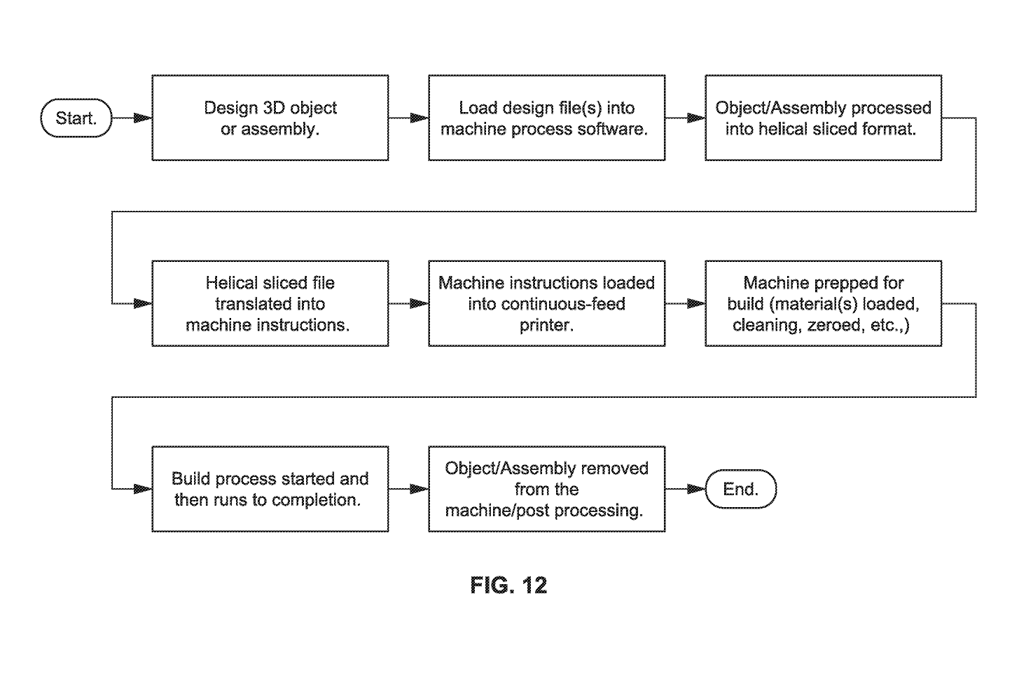

In various implementations, structures to be created with voids are formed by not fusing material and then removing the un-fused material such as by use of “supports” and “support materials” that are easily removed in the post-build processing. It should be appreciated that FIGS. 10 and 11 are divided into wedges and sub-sections for understanding the concepts of the math associated with the fusing process and how the process requires additional information when multiple materials are used simultaneously. However, for the deposition process using powders would be continuous and but there could be artifacts of the fusing process particularly when using lasers to fuse materials. Laser energy is a discrete spot of energy and where the spot is located, the material will fuse. The wedges identify (very roughly) the overall path that a laser spot would take during the fusing process. Likewise, for the embodiment of FIG. 13, it should be understood how the process requires additional information when multiple fusion sources are used simultaneously with each fusion line or flute.

Certain apparatus and methods of the present invention may be utilized with numerical control, either mechanically or in combination with computer control, including through the use of design software providing data points for the 3-D object. In one implementation, the build process is controlled by a purpose-built controller that uses a multi-tasking operating system, for example but not limited to Linux or Windows. The purpose-built controller may be combined with a standard machine controller such as is typically found on a computer numerically controlled (CNC) machine. In one embodiment, a main processing unit will process the appropriate model files to produce a set of G-code instructions that are passed to the CNC machine controller.

The standard processing of the 3D object files must be adapted to accommodate the helical build surface as well as the new options for build processes and multiple materials that may be available. In one embodiment, the processing software is changed from the sliced X-Y layer approach to incorporate a continuous single or multi-flute helical slice approach using multiple or single material fusion sources simultaneously. In other words, instead of slicing the object into X-Y planes in the Z-direction, the software for this method will require that the 3D object(s) be sliced using a moving helical layer or layers which will be continuous in the Z-direction and the machine instructions will be built to follow the helical build surface model. Additional processing instructions will have to be included in the model to incorporate any additional build processes that will be included in the manufacturing process such as the parallel operation of the multiple fusion sources.

FIG. 5 shows a single rotation of a helical surface and a 3D object would have to be sliced into a continuous helical surface as shown in FIG. 6. For example, processing a widget as shown in FIG. 8 would require that the widget be sliced into a continuous helical surface as shown in FIG. 9. FIG. 10 shows how the helical surface will have to be sliced into wedges that are built as material is deposited. For example, when the widget is processed with the intent to build with powdered metal, the material is deposited on the build surface 500/1500 by the material deposition line 300/1300 the laser system 400/1400 or 4011401 would fuse together the portions of the segments of fresh powder as shown in FIG. 10 and by following this procedure repeatedly the widget will be formed into a single unit as shown in FIG. 8 which will be comprised of helical layers as demonstrated in FIG. 9. These figures are for example only and in a real system the layers and segments or wedges will be sized according to the requirements of the build. FIG. 11 shows how each wedge is divided into sub-sections that allow for the processing of different materials that are deposited simultaneously. For example, when the widget is processed with the intent to build with multiple powdered materials, the material is deposited on the build surface 500 by the material deposition line 300/1300 the laser system 400/1400 or 401/1401 would fuse together the portions of the segments of fresh powder as shown in FIG. 10 and FIG. 11 using the laser(s) appropriate for the material and by following this procedure repeatedly the widget will be formed into a single unit as shown in FIG. 8 which will be comprised of helical layers as demonstrated in FIG. 9. These figures are for example only and in a real system the layers and segments or wedges will be sized according to the requirements of the build.

In one implementation, the technique for the helical slicing is a simple line intersection computation for each slice on the helical surface. To generate the build pattern, it is important to consider a continuous rotating surface moving in the z-direction yields a helical build surface. This process consists of mapping a continuous helical surface that matches the build path to the orientation of the part and its location in 3D space relative to the part's final placement on the build plate. Once the part has been mapped to the helical surface that represents the build path, the helical surface is then sliced into thin wedges which are then tested for intersections with the 3D part. From the intersection data, a set of instructions are generated that determine the locations within the wedge where material is processed so as to construct the part. A further processing is required to generate the additional machine instructions required to operate each fusion source in parallel with the other fusion sources during the manufacturing process. As a result of the helical shape of the build surface, a new strategy for determination of the build instructions will be implemented where the 3D objects supplied in the form of 3D description files in formats such as STL, SolidWorks, ProE or others will be processed by slicing the 3D object as a continuous helical spiral and by then slicing the spiral surface into a series of small wedges and wedge sub-sections as shown in FIGS. 10 and 11 that follow a helical path as shown in FIGS. 5 and 6. The wedges are tested to find where the 3D object intersects the wedge and wedge sub-sections which determines which portion of the wedge should be processed and what materials are deposited to form the 3D object.

In one embodiment, the build chamber includes a cured region, a build region and/or an auxiliary region. The build region includes one or more build envelops. The auxiliary region includes auxiliary resources that will supplement the build process. Such resources may be used to supplement the build process prior to materials entering the build chamber, during the build phase in the build chamber, or after the build phase in the build chamber. The equipment included in the auxiliary region may include CNC controlled machine tools, light sources such as lasers or other light or energy sources, material handling equipment, etc., in short, any equipment that will be required in a particular embodiment of the apparatus for supporting or performing the build process.

In one embodiment, the build chamber is open-ended. The open-ended build chamber has material deposited from the “top” and finished product is removed from the “bottom”. The cured product region contains product that has completed the build process and will soon exit through the bottom of the build chamber. In a continuous, uninterrupted process it is envisioned that the build container would exit from the bottom of the machine and the process for this is an automated system comprising a platform that elevates to support the container as it leaves the build chamber and once the build container clears the machine a robotic arm moves the build container to another location for the next step in the process which may be post-processing refinements, build material extraction, shipping, etc.

In an interrupted process that uses externally manufactured build containers it is envisioned that the build container would enter and exit from the bottom of the machine and the process for this is an automated system comprising a robotic arm that installs a build container on a platform that elevates to support and rotate the container and that further rotates and moves the build disk surface as the material is deposited during the build process. After the build is complete, the container leaves the build chamber and once it clears the machine, a robotic arm moves the build container to another location for the next step in the process whether that be post-processing refinements, build material extraction, shipping, etc.

In a continuous, uninterrupted process it is envisioned that the build container is manufactured along with the rest of the build and in this process the completed build chamber along with the manufactured parts would exit from the bottom of the machine. The continuous uninterrupted operation would be possible because, after a job is completed but before the build container exits the build chamber, the next job is started. The initial part of the job is to manufacture the base of the build container which is then used as the initial build surface. While the new job is being manufactured, the new build container is also being manufactured. It is envisioned that a robotic arm grabs the new build chamber and rotates it while also moving the container along the Z-axis. After the new container is controlled by the arm, the finished container exits the bottom of the machine and after it is off-loaded the platform that supported the finished container is then elevated to support the new build that is in progress. Once the platform has taken control of the new build chamber, the robotic arm relinquishes control of the new chamber and moves back into a resting position while it waits for the start of the next build.

FIG. 13 shows an overview of the process of building the widget shown in FIGS. 8 and 9. The start of the process is the design of the object or assembly of objects or system of components using design software such as SolidWorks or ProE. After the object is designed the user exports the design to an appropriate file format. The slicing software reads the design file or files and the user then places the objects into a virtual representation of the build cylinder and locates the parts as required in reference to the build platform. The slicing software then performs the helical slicing of the object, objects, assemblies, etc. included in the build and maps the location of the helical build surface to the location of the objects and the materials required to construct the object(s) or assemblies and this information is then stored in a slice file. The machine control software loads the slice file(s) and then generates the machine instructions required for the build to be performed and then saves the information in a build file. The build file is loaded into the continuous feed printer and after the machine is prepped, the build initiated. After the build is started, the machine runs until the build completes and then the post-processing is performed as required.

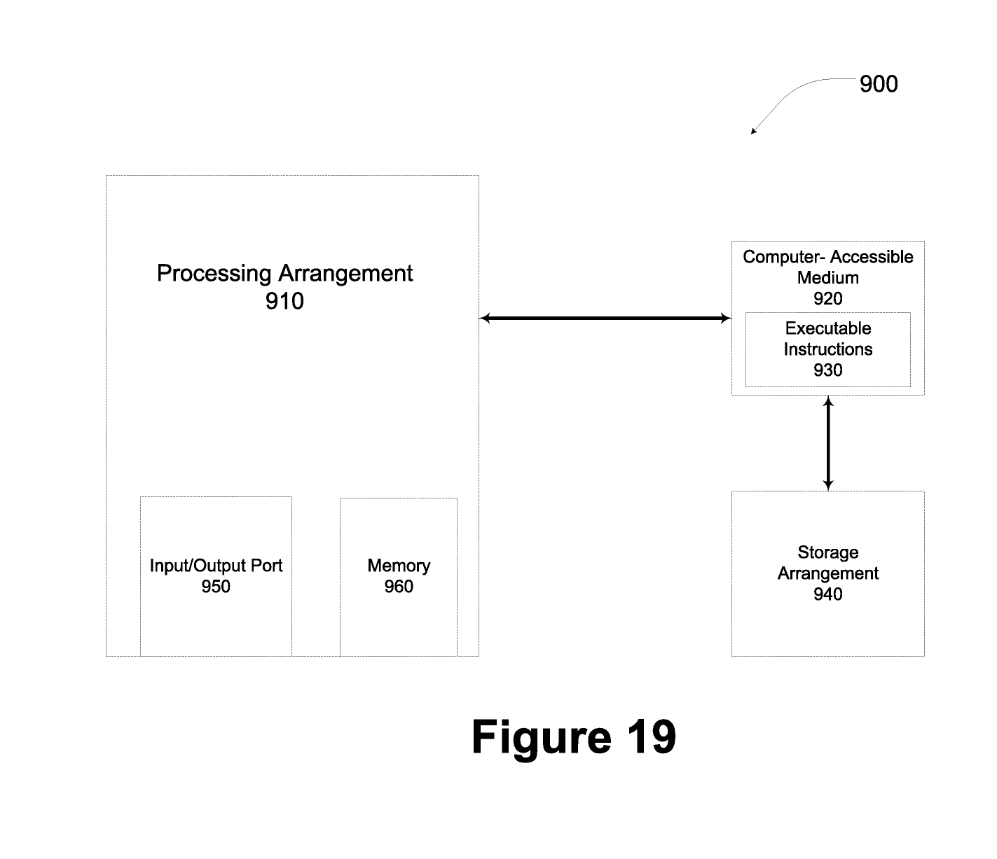

One implementation may utilize a computer system, such as shown in FIG. 19, e.g., a computer-accessible medium 920 (e.g., as described herein, a storage device such as a hard disk, floppy disk, memory stick, CD-ROM, RAM, ROM, etc., or a collection thereof) can be provided (e.g., in communication with the processing arrangement 910). The computer-accessible medium 920 may be a non-transitory computer-accessible medium. The computer-accessible medium 920 can contain executable instructions 930 thereon. In addition or alternatively, a storage arrangement 940 can be provided separately from the computer-accessible medium 920, which can provide the instructions to the processing arrangement 910 so as to configure the processing arrangement to execute certain exemplary procedures, processes and methods, as described herein, for example.

System 900 may also include a display or output device, an input device such as a keyboard, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus for improving the speed of operation of a 3D printing/additive manufacturing process, the apparatus comprising:
a rotatable build deck extending along a x-axis and a y-axis, the build deck movable in a z-axis and rotatable about the z-axis;
a material deposition source positioned for deposition of at least one material on the build deck on a deposition line;
at least one flute having a plurality of fusion sources associated therewith;
wherein the plurality of fusion sources are engageable with the at least one material at a fusion line during a build process.

2. The apparatus of claim 1, further wherein the plurality of fusion sources are each simultaneously engageable along the fusion line.

3. The apparatus of claim 1, wherein the deposition line and the fusion line are co-located and wherein the deposition of material by the material deposition source and the fusion by the plurality of fusion sources occurs simultaneously.

4. The apparatus of claim 1, wherein the deposition line and the fusion line are not co-located and wherein the deposition of material by the material deposition source and the fusion by the plurality of fusion sources occurs simultaneously.

5. The apparatus of claim 1, wherein the material deposition source is an welding deposition source.

6. The apparatus of claim 4, wherein the material deposition source comprises a powdered material source configured to deposit along the build line and multiple fusion sources that fuse the material along the fusion line.

7. The apparatus of claim 6, wherein the plurality of fusion sources are collimated lasers coupled with a set of fixed mirrors that direct the beam(s) to a set of lenses that are mounted on a translation stage that moves the lenses relative to the fusion line and directs collimated laser beams to the fusion line.

8. The apparatus of claim 6, wherein the plurality of fusion sources are collimated lasers coupled with a set of fixed mirrors that direct the beams to a set of rotating mirrors that then direct collimated laser beams to a set of fixed-in-place lenses that focus the collimated laser beams onto the deposited material that is to be fused.

9. The apparatus of claim 6, wherein the plurality of fusion sources are electric arcs or ionized gas plasma streams mounted on a translation stage that moves back-and-forth along the fusion line.

10. The apparatus of claim 2, wherein the material deposition source is an extrusion device comprising multiple extrusion heads mounted on a carriage that moves back and forth along the material deposition line.

11. The apparatus of claim 10, wherein one or more of the multiple extrusion heads has more one type of plastic or other material connected for extrusion.

12. The apparatus of claim 1, wherein the material deposition source comprises multiple wire-feed heads mounted on a carriage that moves back and forth along the material deposition line.

13. The apparatus of claim 10, where each of multiple wire-feed heads has connected thereto more than one type of wire for deposition.

14. The apparatus of claim 1, wherein the material deposition source is an ionic deposition source having multiple ionic deposition heads which are mounted on a carriage that is either fixed or moves back and forth along the material deposition line.

15. The apparatus of claim 1, wherein the material deposition source is a chemical vapor deposition (CVD) source using multiple CVD heads which are mounted on a carriage that is either fixed or moves back and forth along the material deposition line.

16. The apparatus of claim 1, wherein the material deposition source consists of at least one material dispensing mechanism configured for dispensing a material selected from the group consisting of powders, liquids, aerosols, liquefied solids, and liquefied gases.

17. A method of manufacturing a device comprising:
depositing one or more materials onto a rotatable build deck along a deposition line simultaneously from a plurality of material deposition sources, the rotatable build deck allowing for movement along an x-axis, y-axis, and z-axis in three-dimensional space;
fusing deposited one or more material along a fusion line by interacting the deposited one or more material with a plurality of fusion sources;
rotating the build deck about the z-axis; and
positioning the build deck along the z-axis;
wherein a helical build surface is created.

18. A nontransitory computer-readable memory having instructions thereon, the instructions comprising:
instructions for depositing a material onto a rotatable build deck, the rotatable build deck allowing for movement along an x-axis, y-axis, and z-axis in three-dimensional space;
instructions for rotating the build deck about the z-axis; and
instructions for positioning the build deck along the z-axis;
wherein a helical build surface is created using multiple material deposition and fusion sources simultaneously along each flute of a single- or multi-flute system.
